(19) United States
(12) Patent Application Publication
(10) Pub. No.: US 2024/0179785 A1
(43) Pub. Date: May 30, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Wei MA, Shenzhen (CN); Hongjun LIU, Shenzhen (CN); Wu WEN, Shenzhen (CN); Dongmei LI, Shenzhen (CN); Li TIAN, Shenzhen (CN)

(73) Assignee: ZTE CORPORATION, Shenzhen (CN)

(21) Appl. No.: 18/529,521

(22) Filed: Dec. 5, 2023

Related U.S. Application Data
(63) Continuation of application No. PCT/CN2022/105281, filed on Jul. 12, 2022.

(51) Int. Cl. H04W 76/20; H04L 1/1812; H04W 68/02; H04W 74/0836

(52) U.S. Cl. CPC H04W 76/20; H04L 1/1812; H04W 68/02; H04W 74/0836

(57) ABSTRACT

Method, device and computer program product for wireless communication are provided. A method includes: receiving, by a wireless communication terminal from a wireless communication node, a paging message indicating the wireless communication terminal to receive mobile terminated small data transmission, MT-SDT, data via a first MT-SDT resource or a second MT-SDT resource; and receiving, by the wireless communication terminal from the wireless communication node, the MT-SDT data via the first MT-SDT resource or the second MT-SDT resource.

### CROSS-REFERENCE TO RELATED PATENT APPLICATIONS

This application is a Continuation of PCT Application No. PCT/CN2022/105281, filed Jul. 12, 2022, incorporated herein by reference in its entirety.

### TECHNICAL FIELD

This document is directed generally to wireless communications, in particular to 5^{th} generation (5G) wireless communications.

### BACKGROUND

This document is directed generally to wireless communications, and in particular to 5^{th} generation (5G) or 6^{th} generation (6G) wireless communication.

### SUMMARY

In some approaches, the Mobile Originated-SDT (MO-SDT) procedure is used for small data transmission (SDT) for UL (uplink) packets. By allowing transmissions of small and infrequent packets in the RRC (radio resource control) Idle state, the signaling overhead, the power consumption of the UE (user equipment), and the latency of data transmission can be reduced.

The present disclosure relates to methods, devices, and computer program products for mobile terminated small data transmission (MT-SDT).

One aspect of the present disclosure relates to a wireless communication method. In an embodiment, the wireless communication method includes: receiving, by a wireless communication terminal from a wireless communication node, a paging message indicating the wireless communication terminal to receive mobile terminated small data transmission, MT-SDT, data via a first MT-SDT resource or a second MT-SDT resource; and receiving, by the wireless communication terminal from the wireless communication node, the MT-SDT data via the first MT-SDT resource or the second MT-SDT resource.

Another aspect of the present disclosure relates to a wireless communication method. In an embodiment, the wireless communication method includes: transmitting, by a wireless communication node to a wireless communication terminal, a paging message indicating the wireless communication terminal to receive mobile terminated small data transmission, MT-SDT, data via a first MT-SDT resource or a second MT-SDT resource; and transmitting, by the wireless communication node to the wireless communication terminal, the MT-SDT data via the first MT-SDT resource or the second MT-SDT resource.

Another aspect of the present disclosure relates to a wireless communication terminal. In an embodiment, the wireless communication terminal includes a communication unit and a processor. The processor is configured to: receive, from a wireless communication node, a paging message indicating the wireless communication terminal to receive mobile terminated small data transmission, MT-SDT, data via a first MT-SDT resource or a second MT-SDT resource; and receive, from the wireless communication node, the MT-SDT data via the first MT-SDT resource or the second MT-SDT resource.

Another aspect of the present disclosure relates to a wireless communication node. In an embodiment, the wireless communication node includes a communication unit and a processor. The processor is configured to: transmit, to a wireless communication terminal, a paging message indicating the wireless communication terminal to receive mobile terminated small data transmission, MT-SDT, data via a first MT-SDT resource or a second MT-SDT resource; and transmit, to the wireless communication terminal, the MT-SDT data via the first MT-SDT resource or the second MT-SDT resource.

Various embodiments may preferably implement the following features:

Preferably or in some embodiments, the first MT-SDT resource comprises a pre-configured downlink resource.

Preferably or in some embodiments, the second MT-SDT resource comprises a random access resource in a random access procedure.

Preferably or in some embodiments, the paging message comprises an MT-SDT indicator indicating the wireless communication terminal to receive the MT-SDT data.

Preferably or in some embodiments, the MT-SDT indicator comprises an indication on a paging cause with a value for an MT-SDT.

Preferably or in some embodiments, the value for the MT-SDT comprises a first value for using the first MT-SDT resource for the MT-SDT or a second value for using the second MT-SDT resource for the MT-SDT.

Preferably or in some embodiments, the wireless communication terminal receives an MT-SDT configuration for the first MT-SDT resource from the wireless communication node.

Preferably or in some embodiments, the wireless communication terminal receives the MT-SDT configuration in a first RRC message.

Preferably or in some embodiments, the first RRC message comprises an RRC setup message, an RRC reconfiguration message, or an RRC release message.

Preferably or in some embodiments, the wireless communication terminal transmits a second RRC message to the wireless communication node to confirm the MT-SDT configuration.

Preferably or in some embodiments, the MT-SDT configuration comprises at least one of:
frequency domain resource information;
time domain resource information;
a Configured Scheduling Radio Network Temporary Identifier, CS-RNTI; or
Hybrid Automatic Repeat Request, HARQ, information.

Preferably or in some embodiments, the frequency domain resource information comprises Bandwidth Part, BWP, information.

Preferably or in some embodiments, the time domain resource information comprises at least one of an offset of a time-domain resource or an allocation of time-domain resource.

Preferably or in some embodiments, the HARQ information comprises at least one of a number of configured Hybrid Automatic Repeat Request, HARQ, processes for Semi Persistent Scheduling, SPS or an offset of an HARQ process for SPS.

Preferably or in some embodiments, the paging message comprises an MT-SDT indicator indicating the wireless communication terminal to receive the MT-SDT data.

Preferably or in some embodiments, the MT-SDT indicator comprises an indication on a paging cause with a value for the MT-SDT.

Preferably or in some embodiments, the wireless communication terminal receives the MT-SDT data on a slot:

(numberOfSlotsPerFrame×SFN+slot number in the frame)=[numberOfSlotsPerFrame×SFN_{start time}+slot_{start time}]modulo(1024×numberOfSlotsPerFrame),

wherein numberOfSlotsPerFrame denotes a number of slots per frame, SFN denotes a system frame number, SFN_{start time} denotes a system frame number of a start time, and slot_{start time} denotes a slot of the start time.

Preferably or in some embodiments, the wireless communication terminal receives the MT-SDT data on a symbol:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S) modulo(1024×numberOfSlotsPerFrame×numberOfSymbolsPerSlot),

wherein numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

Preferably or in some embodiments, the wireless communication terminal receives the MT-SDT data on a symbol:

[(SFN×numberOfSlotsPerFrame)+(slot number in the frame×numberOfSymbolsPerSlot)]=(timeReferenceSFN×numberOfSlotsPerFrame+timeDomainOffset+S) modulo(1024×numberOfSlotsPerFrame),

wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

Preferably or in some embodiments, the wireless communication terminal receives the MT-SDT data on a physical downlink shared channel, PDSCH, according to the MT-SDT configuration.

Preferably or in some embodiments, the wireless communication terminal receives the MT-SDT data on a PDSCH without a scheduling from the wireless communication node.

Preferably or in some embodiments, the wireless communication terminal receives the MT-SDT data in a Radio Resource Control, RRC, INACTIVE state or an RRC Idle state.

Preferably or in some embodiments, the wireless communication terminal receives an MT-SDT configuration for the second MT-SDT resource from the wireless communication node.

Preferably or in some embodiments, the MT-SDT configuration indicates the wireless communication terminal to receive the MT-SDT data via a message MSG B in a 2-step RACH procedure or a message MSG 2 or a message MSG 4 in a 4-step RACH procedure.

Preferably or in some embodiments, the paging message comprises an MT-SDT indicator indicating the wireless communication terminal to receive the MT-SDT data via a message MSG B in a 2-step RACH procedure or a message MSG 2 or a message MSG 4 in a 4-step RACH procedure.

Preferably or in some embodiments, the wireless communication terminal initiates a 2-step RACH procedure or a 4-step RACH procedure based on the MT-SDT indication paging message.

Preferably or in some embodiments, the wireless communication terminal receives system information comprising an MT-SDT configuration configuring the second MT-SDT resource.

Preferably or in some embodiments, the wireless communication terminal determines initiating a 2-step RACH procedure or a 4-step RACH procedure based on an MT-SDT configuration in system information.

Preferably or in some embodiments, the wireless communication node transmits an MT-SDT configuration for the first MT-SDT resource to the wireless communication terminal.

Preferably or in some embodiments, the wireless communication node transmits the MT-SDT configuration in a first RRC message, and the first RRC message comprises an RRC setup message, an RRC reconfiguration message, or an RRC release message.

Preferably or in some embodiments, the wireless communication node receives a second RRC message from the wireless communication terminal to confirm the MT-SDT configuration.

Preferably or in some embodiments, the wireless communication node transmits the MT-SDT data on a physical downlink shared channel, PDSCH, according to the transmitted MT-SDT configuration.

Preferably or in some embodiments, the wireless communication node transmits the MT-SDT data on a PDSCH without a scheduling to the wireless communication terminal.

Preferably or in some embodiments, the wireless communication node transmits the MT-SDT data to the wireless communication terminal when the wireless communication terminal is in a Radio Resource Control, RRC, INACTIVE state or an RRC Idle state.

Preferably or in some embodiments, the wireless communication node transmits an MT-SDT configuration for the second MT-SDT resource to the wireless communication terminal.

Preferably or in some embodiments, the wireless communication node transmits system information comprising an MT-SDT configuration configuring the second MT-SDT resource to the wireless communication terminal.

The present disclosure also relates to a computer program product comprising a computer-readable program medium code stored thereupon, the code, when executed by a processor, causing the processor to implement a method for data transmission recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a wireless communication terminal according to an embodiment of the present disclosure.

FIG. 2 shows a schematic diagram of a wireless communication node (e.g., a wireless network node) according to an embodiment of the present disclosure.

FIG. 3 shows an example MT-SDT procedure according to an embodiment of the present disclosure.

FIG. 4 shows an example procedure for the MT-SDT for a UE according to an embodiment of the present disclosure.

FIG. 5 shows an example procedure for the MT-SDT for a network according to an embodiment of the present disclosure.

FIG. 6 shows an example procedure for the MT-SDT resource-1 according to an embodiment of the present disclosure.

FIG. 7 shows an example procedure for the MT-SDT resource-2 according to an embodiment of the present disclosure.

### DETAILED DESCRIPTION

In some embodiments, the paging message may be used to transmit paging information to a UE in an RRC Idle or RRC INACTIVE state. The network may initiate the paging procedure by transmitting the paging message at the UE's paging occasion. The network may transmit paging information to multiple UEs with a paging message by including one PagingRecord for each UE in the paging message.

However, it is still unclear about the procedure of a mobile terminated SDT (MT-SDT). In particular, it is still unclear about the MT-SDT mechanism for UEs in the RRC_INACTIVE state, which is able to support Random Access based SDT (RA-SDT) and Configured Grant (CG-SDT) as the UL response, and it is also unclear about the MT-SDT procedure for an initial DL data reception and subsequent UL and/or DL data transmissions in the RRC_INACTIVE state.

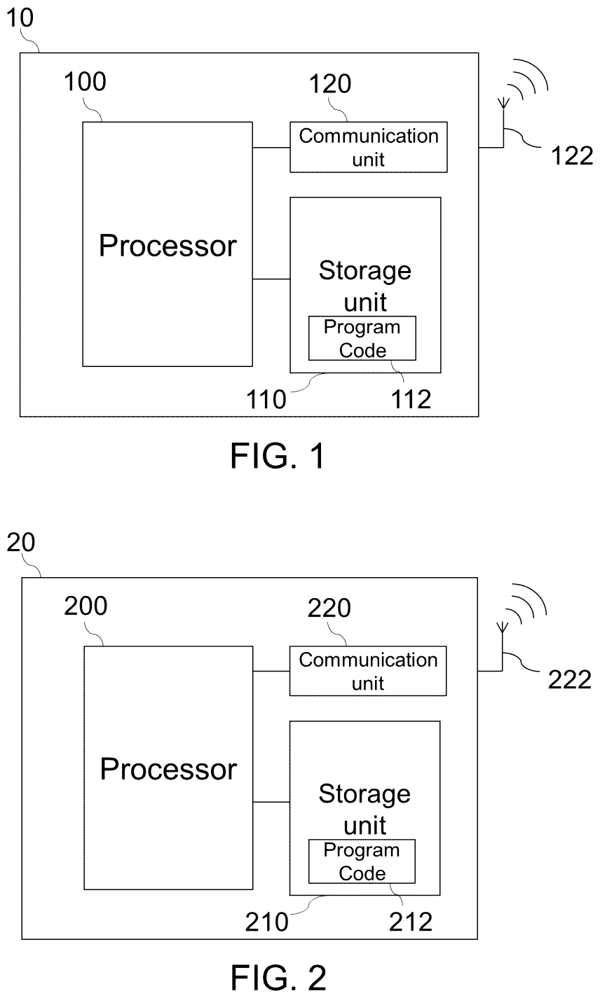

FIG. 1 relates to a schematic diagram of a wireless communication terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

FIG. 2 relates to a schematic diagram of a wireless network node 20 (e.g., a wireless communication node, a network node, or a network) according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In an embodiment, the wireless network node 20 can be the network described below.

### Aspect 1: Procedure of MT-SDT

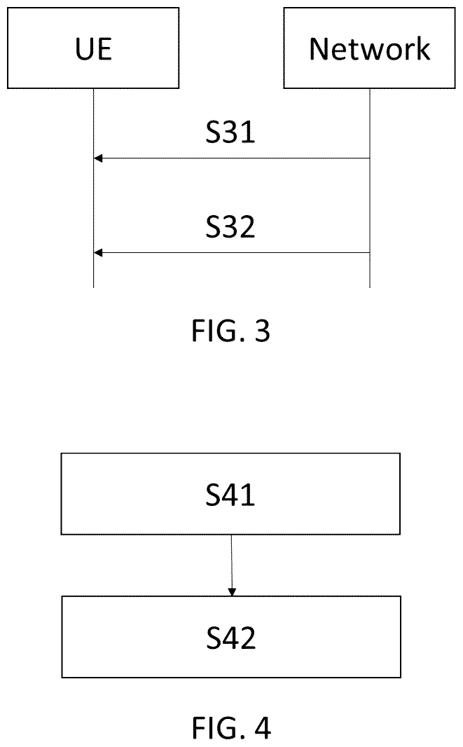

In an embodiment, an example procedure for the MT-SDT is provided according to an embodiment of the present disclosure as shown in FIG. 3.

In step S31: the network wants to send an MT-SDT data to the UE. To do so, the network sends a paging message to the UE to inform the UE to receive the MT-SDT data according to the paging message. In an embodiment, the paging message includes at least one MT-SDT indicator, which indicates that the paging message is for notifying the UE to receive the MT-SDT data and the MD-SDT data may be transmitted by using a chosen MT-SDT resource.

In an embodiment, the chosen MT-SDT resources can be an MT-SDT resource-1 (e.g., a first MT-SDT resource) or an MT-SDT resource-2 (e.g., a second MT-SDT resource). In an embodiment, the MT-SDT indicator may be a paging cause with a specific value, for example, the value may indicate the chosen MT-SDT resource-1 or MT-SDT resource-2. In an embodiment, the MT-SDT resource-1 may a pre-configured downlink resource, and the pre-configured resource may be triggered by the paging message. In an embodiment, the MT-SDT resource-2 is a random access resource, and the MT-SDT data may be transmitted by the MSG B, or MSG4, or MSG2 in a random access procedure.

In step S32: after the paging message has been send to the UE, the network transmits the MT-SDT data to the UE using a DL resource previously configured (e.g., the pre-configured downlink resource or the MSG B or MSG4 or MSG2 in a random access procedure described above). In an embodiment, the UE receives the MT-SDT data on MT-SDT resource-1 or MT-SDT resource-2 according to the paging message. In an embodiment, the UE chooses the MT-SDT resource according to the value of the paging cause in the paging message.

### Aspect 2: Procedure of MT-SDT for UE

In an embodiment, an example procedure for the MT-SDT for the UE according to an embodiment of the present disclosure as shown in FIG. 4.

In step S41: the UE receives a paging message with the MT-SDT indicator from the network. In an embodiment, the indicator triggers the UE to receive the MT-SDT data from network. In an embodiment, the indicator is a paging cause used for the MT-SDT data transmission.

In step S42: the UE receives the MT-SDT data on the chosen MT-SDT resource. The UE chooses the MT-SDT resource according to the value of the paging cause in the paging message.

In an embodiment, the MT-SDT resources includes at least two type of resources: the MT-SDT resource-1 is a pre-configured downlink resource, where the pre- configured resource may be triggered by the paging message; and the MT-SDT resource-2 is random access resource, where the MT-SDT data may be transmitted by the MSG B, or MSG 4, or MSG 2 in a random access procedure.

### Aspect 3: Procedure of MT-SDT for Network

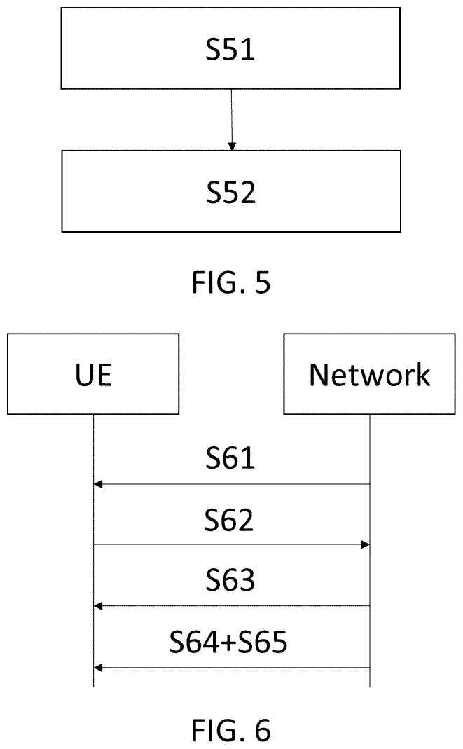

In an embodiment, an example procedure for the MT-SDT for the network according to an embodiment of the present disclosure as shown in FIG. 5.

In step S51: when the network wants to send one or more MT-SDT data to the UE, the network sends a paging message to the UE with an MD-SDT indicator for notifying the UE to receive the MT-SDT data.

In an embodiment, the paging message includes at least one MD-SDT indicator, which indicates that the paging message is for notifying the UE to receive the MT-SDT data and the MD-SDT data may be transmitted by using a chosen MT-SDT resource.

In an embodiment, the chosen MT-SDT resources may be an MT-SDT resource-1 or MT-SDT resource-2. In an embodiment, the MD-SDT indicator may be a paging cause with a specific value. For example, the value may indicate a chosen MT-SDT resource-1 or MT-SDT resource-2.

In an embodiment, the MT-SDT resource-1 may a pre-configured downlink resource, and the pre-configured resource may be triggered by the paging message. In an embodiment, the MT-SDT resource-2 is a random access resource, and the MT-SDT data may be transmitted by the MSG B, or MSG4, or MSG2 in a random access procedure.

In step S52: the network transmits the MT-SDT data on the chosen MT-SDT resource.

### Aspect 4: Procedure for MT-SDT Resource-1

In an embodiment, an example procedure for the MT-SDT resource-1 according to an embodiment of the present disclosure as shown in FIG. 6.

In step S61: the network sends an RRC message1 to the UE to configure the MT-SDT resource (e.g., the DL MT-SDT resource). The RRC message1 can be an RRC Setup message, an RRC reconfiguration message, or an RRC release message.

In an embodiment, the RRC message1 includes an MD-SDT configuration. In an embodiment, the UE may receive the MT-SDT data according to the MD-SDT configuration. In an embodiment, the MD-SDT configuration may include information which indicates the UE to receive the MT-SDT data in the downlink assignment occurring in a slot. In an embodiment, the MD-SDT configuration may include information which indicates the UE to receive the MT-SDT in a specified BWP.

In an embodiment, the MT-SDT configuration may include at least one of:
frequency domain resource information;
time domain resource information;
a Configured Scheduling Radio Network Temporary Identifier (CS-RNTI); and/or
Hybrid Automatic Repeat Request (HARQ) information.

In an embodiment, the frequency domain resource information comprises Bandwidth Part (BWP) information. In an embodiment, the resource for the MT-SDT data includes one or more BWPs.

In an embodiment, the CS-RNTI is configured for activation, deactivation, and retransmission.

In an embodiment, the HARQ information comprises at least one of: a number of configured HARQ processes for Semi Persistent Scheduling (SPS) and/or an offset of an HARQ process for SPS.

In an embodiment, the time domain resource information comprises at least one of an offset of a time-domain resource and/or an allocation of time-domain resource. In an embodiment, the offset of the time-domain resource may be an offset of a resource with respect to the SFN (e.g., thetimeReferenceSFN) in time domain. In an embodiment, the allocation of time-domain resource may be an allocation of the configured uplink grant in time domain which contains a parameter of startSymbolAndLength or startSymbol.

In step S62 (this is an optional step): if the RRC message1 is an RRC Setup message or an RRC reconfiguration message, the UE sends an RRC message2 to the network to confirm the MT-SDT configuration. In an embodiment, if the RRC message1 is RRC release message, the step S62 may be omitted.

In step S63: the network wants to send MT-SDT data to the UE. The network may send a paging message to the UE to inform the UE to receive the MT-SDT data according to the MT-SDT configuration received in the RRC message1 in step S61. The paging message includes an MT-SDT indicator, which indicates that the paging message is notifying the UE to receive the MT-SDT data. The MT-SDT indicator may be a paging cause with a value for the MT-SDT.

In step S64: the network transmits the MT-SDT data to the UE according to the MT-SDT configuration (e.g., according to the MT-SDT resource). In an embodiment, the network transmits the MT-SDT data to the UE using the MT-SDT resource configured by RRC message1 (e.g., by the MT-SDT configuration) in step S61. In an embodiment, the UE monitors the DL MT-SDT resource according to the MT-SDT configuration in RRC message1 and receives the MT-SDT data.

In step S65: the UE receives the MT-SDT data according to the MT-SDT configuration. For example, the UE may:
Receive the MT-SDT data in the one or more BWPs according to the MT-SDT configuration;
Receive the MT-SDT data on the slot/frame/subframe/symbol (time domain source) according to the MT-SDT configuration;
Receive the MT-SDT data on the slot:

(numberOfSlotsPerFrame×SFN+slot number in the frame)=[numberOfSlotsPerFrame×SFN_{start time}+slot_{start time}]modulo(1024×numberOfSlotsPerFrame),

wherein numberOfSlotsPerFrame denotes a number of slots per frame, SFN denotes a system frame number, SFN_{start time} denotes a system frame number of a start time, and slot_{start time} denotes a slot of the start time, and SFN_{start time} and slot_{start time} are the SFN and slot, respectively, of the first transmission of PDSCH (physical downlink shared channel) where the configured downlink assignment is (re-)initialized;
a. or

[(SFN×numberOfSlotsPerFrame)+(slot number in the frame×numberOfSymbolsPerSlot)]=(timeReferenceSFN×numberOfSlotsPerFrame+timeDomainOffset+S) modulo(1024×numberOfSlotsPerFrame),

wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol (e.g., the parameter startSymbol described above);
or
Receive the MT-SDT data on the symbol:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S) modulo(1024×numberOfSlotsPerFrame×numberOfSymbolsPerSlot),

wherein numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

In an embodiment, the MT-SDT configuration may be configured for a Serving Cell per BWP. In an embodiment, the MT-SDT configuration may include information of one or more BWPs. In an embodiment, the MT-SDT data can be transmitted on the one or more BWPs.

In an embodiment, the MT-SDT configuration may include timeDomainAllocation information, where the timeDomainAllocation information defines the time domain resource of the MT-SDT resource.

In an embodiment, the timeDomainAllocation information may include a parameter startSymbolAndLength or startSymbol. Alternatively, the timeDomainAllocation information may include a parameter startSlotAndLength or startSlot.

In an embodiment, the MT-SDT configuration may include a parameter timeDomainOffset, which defines an offset of a time domain resource with respect to SFN (e.g., timeReferenceSFN) in the time domain.

In an embodiment, the MT-SDT configuration may include an identifier, which identifies the UE's MT-SDT transmission.

In an embodiment, the MT-SDT configuration may include HARQ information, for the HARQ operations between the UE and the network.

### Aspect 5: Procedure for MT-SDT Resource-2

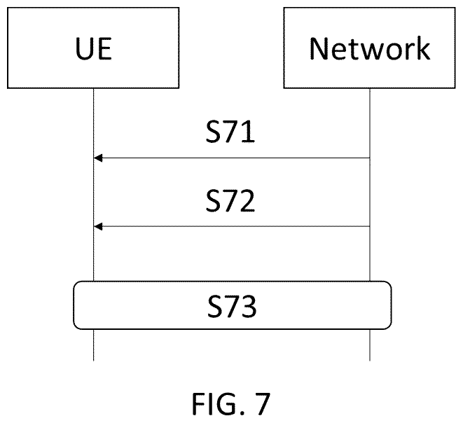

In an embodiment, an example procedure for the MT-SDT resource-2 is provided according to an embodiment of the present disclosure as shown in FIG. 7.

In step S71: the network sends an MT-SDT configuration (e.g., a random access resource configuration) for the MT-SDT resource-2 to the UE. In an embodiment, the MT-SDT configuration comprises a random access resource configuration for the MT-SDT resource-2 (i.e., the random access resource). The random access resource configuration may include an RA-SDT configuration. The RA-SDT configuration is used to transmit the MT-SDT data from the network to the UE.

If a 2-step RACH procedure is used, the network may transmit the MT-SDT data in a message B (i.e., MSG B). Alternatively, if a 4-step RACH procedure is used, the network may transmit the MT-SDT data in a message 4 (i.e., MSG 4) or (i.e., MSG 2).

In step S72: the network transmits a paging message to the UE to notify the UE of the MT-SDT data transmission.

In step S73: the UE initiates a random access procedure, and receives the MT-SDT data in the message B, message 2, or message 4.

An example is provided below, but the present disclosure is not limited thereto.

In an embodiment, the paging message may include an MT-SDT indicator that indicates the network may use a 2-step RACH procedure or 4-step RACH procedure to transmit the MT-SDT data.

In an embodiment, if the UE receives the paging message with an MT-SDT indicator indicating the 2-step RACH MT-SDT transmission, the UE may initiate the 2-step RACH procedure, and may receive the MT-SDT data in the message B.

In an embodiment, the UE receives the paging message with an MT-SDT indicator indicating the 4-step RACH MT-SDT transmission, the UE may initiate the 4-step RACH procedure, and may receive the MT-SDT data in the message 4 or message 2.

Additionally, in the random access resource configuration of step S71, the MT-SDT configuration may include an MT-SDT indicator which indicates that the MT-SDT resource is based on the 2-step RACH or 4-step RACH procedure. Accordingly, if the UE receives the paging message for the MT-SDT transmission, the UE may initiate the 2-step or 4-step RACH procedure based on the random access resource configuration. Furthermore, The UE may initiate the 2-step or 4-step RACH procedure based on the MT-SDT indicator and the MT-SDT configuration.

In an embodiment, if the MT-SDT indicator indicates the MT-SDT resource is based on a 2-step RACH procedure, the UE may initiate the 2-step RACH procedure to receive the MT-SDT data on the message B in the 2-step RACH procedure.

In an embodiment, if the MT-SDT indicator indicates the MT-SDT resource is based on a 4-step RACH procedure, the UE may initiate the 4-step RACH procedure to receive the MT-SDT data on the message 2 or message 4 in the 4-step RACH procedure.

### Aspect 6: Paging Message

In an embodiment, there are a few possible values for the paging cause in the paging message.

For example, a value of “CG-SDT” is used for indicating that the network may send the MT-SDT data to the UE by using the MT-SDT resource-1.

In an embodiment, the MT-SDT resource-1 is the pre-configured downlink resource mentioned above.

As another example, a value of “RA-SDT” is used for indicating that the network may send the MT-SDT data to the UE by using the MT-SDT resource-2.

In an embodiment, the MT-SDT resource 2 is a random access resource mentioned above.

In an embodiment, when the UE receives a paging message including a paging cause with the value of “CG-SDT”, the UE may monitor and receive the MT-SDT data on the pre-configured resource.

In an embodiment, when the UE receives a paging message including a paging cause with the value of “RA-SDT”, the UE may initiate a random access procedure to receive the MT-SDT data on the random access resource.

### Aspect 7: System Information

In an embodiment, the UE may receive System information from the network including an MT-SDT configuration with a RACH Type having a value of “2-step RACH”. Besides, the UE in an RRC Inactive state may receive a paging message with a paging cause of “MT-SDT”, “RA-SDT” or “CG-SDT”.

According to the System information and the paging message, the UE may initiate a 2-step RACH procedure with the network, and send the message A to the network. Subsequently, the UE may receive the MT-SDT data in the message B from the network.

In an embodiment, the UE may receive System information from the network including an MT-SDT configuration with a RACH Type having a value of “4-step RACH”. Besides, the UE in an RRC Inactive state may receive a paging message with a paging cause of “MT-SDT”, “RA-SDT” or “CG-SDT”.

According to the System information and the paging message, the UE may initiate a 4-step RACH procedure with the network, and send the message 1 to the network. Subsequently, the UE may receive message 2 from the network and obtain the uplink resource for the meesage3. Accordingly, the UE may send message 3 to the network with an MT-SDT indication. Subsequently, the UE may receive the MT-SDT data in the message 4 from the network.

In accordance with an embodiment of the present disclosure, the network may send a paging message to the UE to inform the UE to receive the MT-SDT data according to the paging message. In an embodiment, the paging message includes at least one MT-SDT indicator, which indicates that the paging message notifies the UE to receive the MT-SDT data and the MT-SDT data may be transmitted using the chosen SDT resource.

In accordance with an embodiment of the present disclosure, the UE may receive the MT-SDT data according to the paging message. In an embodiment, the UE may receive two MT-SDT configurations separately for the MT-SDT resource-1 and MT-SDT resource-2 and choose one of the MT-SDT configurations according to the paging message. Then, the UE may receive the MT-SDT data according to the chosen MT-SDT configuration.

In accordance with an embodiment of the present disclosure, when the UE receives the paging message, the UE may initiate a random access procedure with the network.

In an embodiment, the UE may select one of two or more types of random access procedure (e.g., 2 step RACH procedure, 4 step RACH procedure) according to the paging message, and initiate the chosen type of random access procedure.

In an alternative embodiment, the UE may select one of two or more types of random access procedure according to a random access resource configuration, and initiate the selected type random access procedure.

In an alternative embodiment, the UE may select one of two or more types of random access procedure according to system information, and initiate the selected type random access procedure.

In accordance with an embodiment of the present disclosure, a wireless communication method includes: receiving, by a wireless communication terminal (e.g., the UE described above) from a wireless communication node (e.g., the network described above), a paging message indicating the wireless communication terminal to receive mobile terminated small data transmission, MT-SDT, data via a first MT-SDT resource (e.g., the MT-SDT resource-1) or a second MT-SDT resource (e.g., the MT-SDT resource-2); and receiving, by the wireless communication terminal from the wireless communication node, the MT-SDT data via the first MT-SDT resource or the second MT-SDT resource.

In an embodiment, the paging message comprises an MT-SDT indicator indicating the wireless communication terminal to receive MT-SDT data.

In an embodiment, the MT-SDT indicator comprises an indication on a paging cause with a value for an MT-SDT.

In an embodiment, the value for the MT-SDT comprises a first value for using the first MT-SDT resource for the MT-SDT or a second value for using the second MT-SDT resource for the MT-SDT.

In an embodiment, the wireless communication terminal receives an MT-SDT configuration for the first MT-SDT resource from the wireless communication node.

In an embodiment, the wireless communication terminal receives an MT-SDT configuration for the second MT-SDT resource from the wireless communication node.

In an embodiment, the MT-SDT configuration indicates the wireless communication terminal to receive the MT-SDT data via a message MSG B in a 2-step RACH procedure or a message MSG 2 or a message MSG 4 in a 4-step RACH procedure.

In an embodiment, the paging message comprises an MT-SDT indicator indicating the wireless communication terminal to receive the MT-SDT data via a message MSG B in a 2-step RACH procedure or a message MSG 2 or a message MSG 4 in a 4-step RACH procedure.

In an embodiment, the wireless communication terminal initiates a 2-step RACH procedure or a 4-step RACH procedure based on the MT-SDT indication paging message.

In an embodiment, the wireless communication terminal receives system information comprising an MT-SDT configuration configuring the second MT-SDT resource.

In an embodiment, the wireless communication terminal determines initiating a 2-step RACH procedure or a 4-step RACH procedure based on an MT-SDT configuration in system information.

In accordance with an embodiment of the present disclosure, a wireless communication method includes: transmitting, by a wireless communication node to a wireless communication terminal, a paging message indicating the wireless communication terminal to receive mobile terminated small data transmission, MT-SDT, data via a first MT-SDT resource or a second MT-SDT resource; and transmitting, by the wireless communication node to the wireless communication terminal, the MT-SDT data via the first MT-SDT resource or the second MT-SDT resource.

Details of these wireless communication methods can be ascertained by referring to the embodiments above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a wireless communication node, a paging message indicating the wireless communication terminal to receive mobile terminated small data transmission (MT-SDT) data via a first MT-SDT resource or a second MT-SDT resource; and
receiving, by the wireless communication terminal from the wireless communication node, the MT-SDT data via the first MT-SDT resource or the second MT-SDT resource.

2. The wireless communication method of claim 1, wherein the first MT-SDT resource comprises a pre-configured downlink resource.

3. The wireless communication method of claim 1, wherein the second MT-SDT resource comprises a random access resource in a random access procedure.

4. The wireless communication method of claim 1, wherein the paging message comprises an MT-SDT indicator indicating the wireless communication terminal to receive the MT-SDT data, wherein the MT-SDT indicator comprises an indication on a paging cause with a value for an MT-SDT, and wherein the value for the MT-SDT comprises a first value for using the first MT-SDT resource for the MT-SDT or a second value for using the second MT-SDT resource for the MT-SDT.

5. The wireless communication method of claim 1, wherein the wireless communication terminal receives an MT-SDT configuration for the first MT-SDT resource from the wireless communication node, wherein the wireless communication terminal receives the MT-SDT configuration in a first radio resource control (RRC) message, and the RRC message is an RRC setup message, an RRC reconfiguration message, or an RRC release message, and wherein the wireless communication terminal transmits a second RRC message to the wireless communication node to confirm the MT-SDT configuration.

6. The wireless communication method of claim 5, wherein the MT-SDT configuration comprises at least one of:
frequency domain resource information;
time domain resource information;
a Configured Scheduling Radio Network Temporary Identifier (CS-RNTI); or
Hybrid Automatic Repeat Request (HARQ) information, and
wherein the frequency domain resource information comprises Bandwidth Part (BWP) information;
the time domain resource information comprises at least one of an offset of a time-domain resource or an allocation of time-domain resource; and
the HARQ information comprises at least one of a number of configured Hybrid Automatic Repeat Request (HARQ) processes for Semi Persistent Scheduling (SPS) or an offset of an HARQ process for SPS.

7. The wireless communication method of claim 1, wherein the wireless communication terminal receives the MT-SDT data on a slot:
(numberOfSlotsPerFrame×SFN+slot number in the frame)=[numberOfSlotsPerFrame×SFN_{start time}+slot_{start time}]modulo(1024×numberOfSlotsPerFrame),
wherein numberOfSlotsPerFrame denotes a number of slots per frame, SFN denotes a system frame number, SFN_{start time} denotes a system frame number of a start time, and slot_{start time} denotes a slot of the start time.

8. The wireless communication method of claim 1, wherein the wireless communication terminal receives the MT-SDT data on a symbol:
[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S) modulo(1024×numberOfSlotsPerFrame×numberOfSymbolsPerSlot),
wherein numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

9. The wireless communication method of claim 1, wherein the wireless communication terminal receives the MT-SDT data on a symbol:
[(SFN×numberOfSlotsPerFrame)+(slot number in the frame×numberOfSymbolsPerSlot)]=(timeReferenceSFN×numberOfSlotsPerFrame+timeDomainOffset+S) modulo(1024×numberOfSlotsPerFrame),
wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

10. The wireless communication method of claim 1, wherein the wireless communication terminal receives an MT-SDT configuration for the second MT-SDT resource from the wireless communication node, wherein the MT-SDT configuration indicates the wireless communication terminal to receive the MT-SDT data via a message MSG B in a 2-step random access channel (RACH) procedure or a message MSG 2 or a message MSG 4 in a 4-step RACH procedure, and.

11. The wireless communication method of claim 10, wherein the paging message comprises an MT-SDT indicator indicating the wireless communication terminal to receive the MT-SDT data via a message MSG B in a 2-step RACH procedure or a message MSG 2 or a message MSG 4 in a 4-step RACH procedure, and wherein the wireless communication terminal initiates a 2-step RACH procedure or a 4-step RACH procedure based on the MT-SDT indication paging message.

12. The wireless communication method of claim 1, wherein the wireless communication terminal receives system information comprising an MT-SDT configuration configuring the second MT-SDT resource, and wherein the wireless communication terminal determines initiating a 2-step RACH procedure or a 4-step RACH procedure based on an MT-SDT configuration in system information.

13. A wireless communication method comprising:
transmitting, by a wireless communication node to a wireless communication terminal, a paging message indicating the wireless communication terminal to receive mobile terminated small data transmission (MT-SDT) data via a first MT-SDT resource or a second MT-SDT resource; and
transmitting, by the wireless communication node to the wireless communication terminal, the MT-SDT data via the first MT-SDT resource or the second MT-SDT resource.

14. The wireless communication method of claim 13, wherein the first MT-SDT resource comprises a pre-configured downlink resource, and wherein the second MT-SDT resource comprises a random access resource in a random access procedure.

15. The wireless communication method of claim 13, wherein the paging message comprises an MT-SDT indicator indicating the wireless communication terminal to receive the MT-SDT data, wherein the MT-SDT indicator comprises an indication on a paging cause with a value for an MT-SDT, and wherein the value for the MT-SDT comprises a first value for using the first MT-SDT resource for the MT-SDT or a second value for using the second MT-SDT resource for the MT-SDT.

16. The wireless communication method of claim 13, wherein the wireless communication node transmits an MT-SDT configuration for the first MT-SDT resource to the wireless communication terminal, wherein the wireless communication node transmits the MT-SDT configuration in a first radio resource control (RRC) message, and the RRC message is an RRC setup message, an RRC reconfiguration message, or an RRC release message, and wherein the wireless communication node receives a second RRC message from the wireless communication terminal to confirm the MT-SDT configuration.

17. The wireless communication method of claim 16, wherein the MT-SDT configuration comprises at least one of:
frequency domain resource information;
time domain resource information;
a Configured Scheduling Radio Network Temporary Identifier (CS-RNTI); or
Hybrid Automatic Repeat Request (HARQ) information; and
wherein the frequency domain resource information comprises Bandwidth Part (BWP) information;
the time domain resource information comprises at least one of an offset of a time-domain resource or an allocation of time-domain resource; and
the HARQ information comprises at least one of a number of configured Hybrid Automatic Repeat Request (HARQ) processes for Semi Persistent Scheduling (SPS) or an offset of an HARQ process for SPS.

18. The wireless communication method of claim 13, wherein the wireless communication node transmits an MT-SDT configuration for the second MT-SDT resource to the wireless communication terminal, wherein the MT-SDT configuration indicates the wireless communication terminal to receive the MT-SDT data via a message MSG B in a 2-step random access channel (RACH) procedure or a message MSG 2 or a message MSG 4 in a 4-step RACH procedure, and wherein the paging message comprises an MT-SDT indicator indicating the wireless communication terminal to receive the MT-SDT data via a message MSG B in a 2-step RACH procedure or a message MSG 2 or a message MSG 4 in a 4-step RACH procedure.

19. The wireless communication method of claim 13, wherein the wireless communication node transmits system information comprising an MT-SDT configuration configuring the second MT-SDT resource to the wireless communication terminal, and wherein the MT-SDT configuration indicates the wireless communication terminal to initiate a 2-step RACH procedure or a 4-step RACH procedure.

20. A wireless communication terminal, comprising:
a communication unit; and
a processor configured to: receive, via the communication unit from a wireless communication node, a paging message indicating the wireless communication terminal to receive mobile terminated small data transmission (MT-SDT) data via a first MT-SDT resource or a second MT-SDT resource; and receive, from the wireless communication node, the MT-SDT data via the first MT-SDT resource or the second MT-SDT resource.
